(19) United States
(12) Patent Application Publication
(10) Pub. No.: US 2019/0288328 A1
(43) Pub. Date: Sep. 19, 2019

(54) LITHIUM-ION BATTERY WITH WIRE-CONTAINING ELECTRODES

(71) Applicant: GM GLOBAL TECHNOLOGY OPERATIONS LLC, Detroit, MI (US)

(72) Inventors: Zhiqiang Yu, Shanghai (CN); Xiaochao Que, Shanghai (CN); Haijing Liu, Shanghai (CN); Wentian Gu, Shanghai (CN); Meiyuan Wu, Shanghai (CN)

(21) Appl. No.: 16/304,718

(22) PCT Filed: Jun. 21, 2016
(86) PCT No.: PCT/CN2016/086550

§ 371 Date: Nov. 27, 2018

(51) Int. Cl. H01M 10/0525; H01M 10/04; H01M 4/134; H01M 4/1391

(52) U.S. Cl. CPC H01M 10/0525; H01M 4/1391; H01M 4/134; H01M 10/0418

(57) ABSTRACT

The electrical performance and structural integrity of lithium battery electrodes, formed of particles of active electrode materials, are improved by mixing electrically conductive wires (metal wires, carbon fibers, and/or the like, including chemically-reduced metal oxide particles) with the particles of active electrode material. For example, copper wires may be intimately mixed with anode particles in porous anode layers which are resin-bonded to sides of a copper current collector foil. And aluminum wires may be mixed with cathode particles in porous cathode layers resin bonded to an aluminum current collector. The wires may be used to increase both the conductivity of electrons and lithium ions and the flexibility of the electrode layer when the electrodes are infiltrated with a solution of a lithium salt electrolyte. The workable thickness of each electrode layer can thus be increased and its performance enhanced to produce a lower cost and better forming battery.

### TECHNICAL FIELD

This disclosure pertains to compositions of electrode materials for lithium batteries. The compositions comprise a mixture of particles of active electrode materials mixed with suitably sized and shaped conductive metal wires, tubes, strips, or rods, or mixed with carbon fibers or tubes (all referred to as wires). The particle/wire mixture, often including electrically conductive filler particles, is resin-bonded as a porous layer to an electrode current collector. The anode or cathode (or both) active material layers of each battery cell are made of such mixtures of particles and wires. The presence of the wires permits of use of thicker electrode layers with higher energy capacity and with improved electron and ionic conductivity in the electrode.

### BACKGROUND OF THE INVENTION

The material presented as background information in this section of the specification is not necessarily prior art.

Lithium-ion batteries are being adapted for applications in electrically powered automotive vehicles and in hybrid vehicles utilizing both an internal combustion engine and an electrical motor to power the vehicle. Other non-vehicle applications also utilize lithium batteries of various combinations of electrode materials for providing electrical power.

In a common design of the cells of a lithium-ion battery, the electrodes are formed of a porous layer of micrometer-size particles of active anode material or active cathode material bonded to one or both sides of a thin, electrically conductive metal foil. The metal foil serves as a current collector for the electrode. In one group of battery structures, the electrodes are formed as relatively thin rectangular members. Like-sized anodes and cathodes are stacked alternately with a thin porous separator layer between each set of facing porous layers of particulate anode and cathode materials. The pores of each separator layer and each layer of electrode material are filled with an electrolyte solution of a lithium salt(s) dissolved in a non-aqueous solvent. The DC potential of each cell is typically in the range of about two to four volts. The electrical current producing energy (Wh) of a cell depends largely on the compositions and amounts of electrode materials that can be accommodated in the preparation and function of each electrode. There is a continuing need for electrode compositions for lithium batteries that can provide increased electric energy and power, and at lower costs.

### SUMMARY OF THE INVENTION

This invention pertains to compositions and the preparation of electrode materials for anodes and cathodes of electrochemical cells in which lithium ions are intercalated and de-intercalated at the porous electrodes which are infiltrated with a non-aqueous electrolyte solution of one or more lithium salts. For example, micrometer-size graphite particles may be used as the active lithium-ion battery anode material and like-size particles of lithium nickel manganese cobalt oxide (LiNiₓMn_{y}Co_{(1-x-y)}O₂, NMC) may be used as the active lithium-ion battery cathode material. In order to increase the capacity of each electrode and its conductivity of ions and electrons, the respective active electrode material particles are mixed with micrometer-scale diameter, electrically conductive metal wires and/or carbon fibers (referred to as wires herein), and the mixture bonded as a porous layer of substantially uniform thickness to a compatible metal foil current collector. Anode electrode materials may, for example, be formed of a mixture of graphite particles and small-diameter copper wires, and the mixture resin-bonded as a porous layer to a copper current collector foil. Similarly, cathode materials may be formed of a mixture of NMC particles and small-diameter aluminum wires and the mixture resin-bonded as a porous layer to an aluminum current collector foil. Particles of an electrically conductive filler, such as particles of conductive carbon, are also preferably included in resin-bonded mixtures of electrode materials.

The electrodes of conventional lithium-ion cells are often formed by bonding particles of active electrode materials that have a largest dimension in the range of about 0.5 to 30 micrometers to a compatible metal current collector foil having a thickness of about 5 to 30 micrometers. As stated, the shape of the current collector is often rectangular with side dimensions that provide a surface area to enable it to support a predetermined quantity of electrode material for a lithium-ion battery cell. Each side of the current collector foil may be coated with a porous layer of particles of electrode material, but the sustainable thickness of each layer is usually limited to about 15 μm to 150 μm. This limitation on the amount of electrode material sustainable on this type of electrode structure also limits the power and energy density capabilities of each cell using such an electrode design. The use of small metal or carbon wires, suitably intermixed with the particles of active electrode materials enables the use of thicker porous electrode coatings (e.g., up to about two millimeters) on each side of the current collector foil. And the small pieces of electrically conductive wires, added to one or both of the anode and cathode materials, enhance the energy-producing performance of this new battery cell.

In practices of this invention, the term “wire” is intended to include small conductive carbon or metal (including elemental metals or alloys) wires, threads, fibers, pieces, or the like, having a length substantially greater than their width or diameter. Preferably the lengths of the metal or carbon wires are in the range of one micrometer to ten millimeters. The metal or carbon wires or threads are generally round in solid cross-section with a diameter, much smaller than their length, in the range of 0.05 μm to 100 μm. Small diameter metal rods of like dimensions may also be suitable for mixing with active electrode material particles. Alternatively, the metal or carbon wires may be in the form of tubes with lengths and outside diameters like those stated for wires. Or the metal or carbon pieces may be in the form of strips with lengths 1 μm to 10 mm, widths of 1 μm to 100 μm and thicknesses of 0.05 μm to about 50 μm. The term “wires” as used in this specification is intended to include all such conductive metal or conductive carbon shapes having a length substantially longer than the dimension of their external cross-section. The surfaces of the conductive metal wires may also be coated with conductive carbon particles using a suitable polymer binder. The resin-bonded coating of conductive carbon particles may be about 0.5 to 5 μm thick. The amount of polymer binder is controlled such that the wires have uncoated portions which will be exposed to a liquid electrolyte in an assembled battery cell.

Thus, the wires that are to be mixed with the small electrode particles have lengths that are larger than the largest dimensions of the electrode particles. It is intended that in a wire-particle mixture, several particles are in contact with each wire, and many more electrode material particles are in near-contact with each piece of wire. Some wires in the mixture may extend through the thickness of a finished porous electrode layer, and some wires may contact the surface of the current collector to which a porous layer of the electrode mixture is bonded. In general, it is preferred that the lengths of the wires be no longer than about ten times the intended thickness of the porous electrode layer.

In general, it is preferred that the carbon or metal composition of the wires used in an electrode particle mixture be chemically and electrically compatible with the metal composition of the current collector foil to which the mixture is resin-bonded. For example, an aluminum current collector foil is often used in the formation of cathodes for many lithium-ion batteries. In such cathode materials, the metal wires mixed with micrometer-size particles of cathode material may include elemental aluminum or aluminum alloy wires, gold wires, palladium wires, platinum wires, titanium wires, or stainless steel wires. Carbon fibers (herein, sometimes referred to as wires) are also compatible with aluminum current collectors. In anode members in which the current collector is formed of copper, the metal wires mixed with micrometer-size particles may be selected from elemental copper or copper alloy wires or wires of stainless steel, silver, gold, palladium, platinum, titanium, iron, cobalt, nickel, magnesium, or aluminum. Again, carbon fibers or threads (wires) are compatible with copper current collectors.

Many such metal and carbon wire compositions are commercially available in diameters or widths in the low micrometer size range and with lengths in the micrometer to low-millimeter range.

Further, in some embodiments of the invention, it may be preferred to start with small elongated particles, wires, or fibers of a metal oxide such as copper oxide or silver oxide. Once such metal oxide particles have been suitably mixed with compatible electrode particles, the mixture is applied as a porous resin-bonded electrode layer to one or both surfaces of a current collector foil. The oxide particles in the bonded porous electrode layer are chemically reduced to elemental metal wires by reaction with hydrogen at a temperature of about 120° to 150° C. The porous electrode layer then consists of a mixture of electrode material particles and elemental metal wires of a desired shape and size. Often such metal oxide particles experience considerable shrinkage (e.g., 30-50 vol. %) as they are chemically reduced, depending on their original particle length. The chemically reduced wire-like structures often contain channels which increase ion conductivity in an assembled lithium-ion cell

In an illustrative example, a mixture of carbon electrode particles (graphite) and copper wires may be prepared as an anode material. The typical dimension of the carbon particles is about ten to twenty micrometers and the diameter of the copper wires is also about ten micrometers. The lengths of the copper wires are suitably about three hundred micrometers. The active anode material is then composed of about 20 wt % copper wires and the balance graphite. The graphite/copper wire mixture is slurried with a solution of, for example, polyvinylidene difluoride in N-methyl-2-pyrrolidone (NMP) solvent, and the solvent-wet mixture carefully applied to each side of a copper current collector foil in uniform layers, each about three hundred micrometers in thickness. The solvent is evaporated to leave porous layers of anode material in each side of the current collector.

A cathode may be prepared in a similar manner using like-size particles of lithium nickel manganese cobalt oxide and aluminum wires.

Lithium-ion cells utilizing wire-containing electrodes in accordance with this invention may be used in lithium batteries for powering electric motors in automotive vehicles which are powered solely by an electric motor or by the hybrid combination of an internal combustion engine and an electric motor.

Other practices and advantages of the invention will be apparent from further illustrative examples presented below in this specification.

### BRIEF DESCRIPTION OF THE DRAWINGS

FIG. 1 is an enlarged schematic illustration of a spaced-apart assembly of three solid members of a lithium-ion electrochemical cell. Small portions of electrode layers are broken out and enlarged to show the porous mixture of small electrode particles and conductive wires. The three solid members are spaced apart in this illustration to better show their structure. This figure illustration does not include an electrolyte solution whose composition and function will be described in more detail below in this specification.

FIG. 2 is an enlarged, broken-out, schematic illustration of a porous layer of particles of cathode material mixed with aluminum wires and bonded to an aluminum foil current collector, and a porous layer of anode particles mixed with copper wires and bonded to a copper current collector foil. The unbounded sides of the porous electrode layers are pressed against opposite sides of a co-extensive porous polymeric separator member.

FIG. 3 is a schematic cross-sectional side view of an anode current collector foil coated on both major sides with a mixture of active anode material particles and metal wires for a lithium-ion battery anode, a cathode current collector foil coated on both sides with a mixture of active cathode material particles and metal wires for a lithium-ion battery cathode. The two electrodes are rectangular in shape (not visible in this side view, but as illustrated in FIG. 1). The opposing major faces of the anode and cathode are physically separated by a porous rectangular polymer separator layer wound from the full outer surface of the cathode, around one edge of the cathode to fully cover the inner face of the cathode and separate it from the adjoining face of the anode, around the edge of the anode to cover the outer face of the anode. The two electrodes with their wire-containing and particulate electrode materials are placed within a closely spaced pouch container. The pouch contains a non-aqueous electrolyte solution which permeates and fills the pores of the separator and of the respective active anode and cathode coating layers. The respective current collector foils have uncoated tabs extending up from their top sides and through the top surface of the pouch container.

### DESCRIPTION OF PREFERRED EMBODIMENTS

An active lithium-ion cell material is an element or compound which accepts or intercalates lithium ions, or releases or gives up lithium ions in the discharging and re-charging cycling of the cell. In accordance with practices of this invention the respective electrode materials are typically initially in the form of submicron to micron-size particles, in the range of tens of nanometers to tens of microns in their diameters or largest dimension.

A few examples of suitable electrode materials for the anode electrode (negative electrode during discharge of the cell) of a lithium ion cell are graphite, some other forms of carbon, silicon, alloys of silicon with lithium or tin, silicon oxides (SiOₓ), and lithium titanate. During cell-discharge, electrons are released from the anode material into the electrical power-requiring external circuit and lithium ions are released (de-intercalated) into an anhydrous lithium ion conducting electrolyte solution. In practices of this invention, the small particles of a selected anode material are mixed with a suitable quantity of suitably sized electrically conductive metal and/or carbon wires.

Examples of positive electrode materials (cathode), used in particulate form, include lithium manganese oxide, lithium nickel oxide, lithium cobalt oxide, lithium nickel manganese cobalt oxide, and other lithium-metal-oxides. Other materials are known and commercially available. One or more of these materials may be used in an electrode layer. In practices of this invention, the small particles of a selected cathode material are mixed with a suitable quantity of suitably sized electrically conductive metal and/or carbon wires.

As stated above in this specification, an aluminum current collector foil is often used in the formation of cathodes for many lithium-ion batteries. In such cathode materials, the metal wires mixed with micrometer-size particles of cathode material may include elemental aluminum or aluminum alloy wires, gold wires, palladium wires, platinum wires, titanium wires, or stainless steel wires. Carbon wires may be mixed with metal wires in mixtures with particles of active cathode material, or used in place of metal wires. In anode members in which the current collector is formed of copper, the metal wires mixed with micrometer-size particles may be selected from elemental copper or copper alloy wires or wires of stainless steel, silver, gold, palladium, platinum, titanium, iron, cobalt, nickel, magnesium, or aluminum. Carbon wires may be mixed with metal wires in mixtures with particles of active anode material, or used in place of metal wires.

Particles of lithium titanate (Li₄Ti₅O₁₂) are widely used as the active anode material. It is preferred to use lithium titanate anode particles in combination with aluminum wires or aluminum alloy wires. And when the anode material uses lithium titanate particles, it is preferred that the lithium titanate particle/aluminum wire mixture be resin-bonded to an aluminum current collector foil.

Many copper wire and other metal wire compositions are commercially available in diameters or widths in the low micrometer size range and with lengths in the micrometer to low-millimeter range.

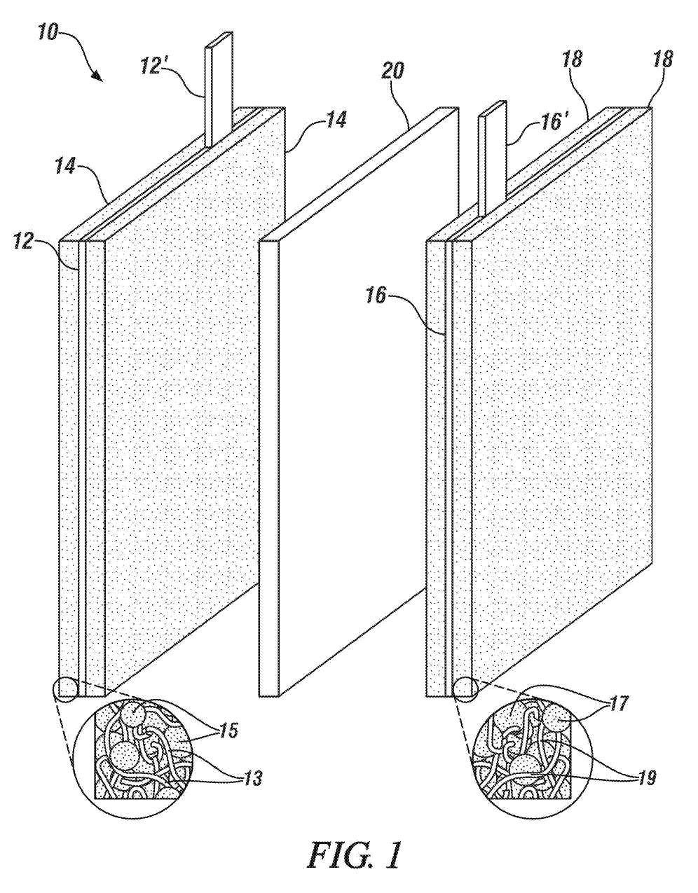

FIG. 1 is an enlarged schematic illustration of a spaced-apart assembly 10 of three solid members of a lithium-ion electrochemical cell. The three solid members are spaced apart in this illustration to better show their structure. The illustration does not include an electrolyte solution whose composition and function will be described in more detail below in this specification.

In FIG. 1, a negative electrode consists of a relatively thin, conductive metal foil current collector 12. The negative electrode current collector 12 is typically formed of a thin layer of copper. The thickness of the metal foil current collector is often in the range of about six to twenty-five micrometers. The current collector 12 has a desired two-dimensional shape for assembly (e.g., stacking or winding) with other solid members of a cell. Current collector 12 is illustrated as having opposing major surfaces with a rectangular shape, and further provided with a connector tab 12′ for connection with other electrodes in a grouping of lithium-ion cells to provide a desired electrical potential or electrical current flow.

Deposited on both major faces of the negative electrode current collector 12 are thin, resin-bonded porous layers 14 of particles of a suitable negative electrode material mixed with compatible metal wires. For example particles of carbon (graphite) may be mixed with copper wires. As illustrated in FIG. 1, the layers of negative electrode material 14 are typically co-extensive in shape and area with the main surfaces of their current collector 12. A small portion of porous layer 14 is broken-out and enlarged to illustrate a suitably bonded, porous mixture of copper wires 13 and graphite particles 15 which form the negative electrode layer 14. If desired, conductive carbon filler particles may be added to copper wires and graphite particles. The mixture of particulate electrode material and metal wires has sufficient porosity to be infiltrated by a liquid, non-aqueous, lithium-ion containing electrolyte. In accordance with embodiments of this invention, the thickness of the rectangular layers of graphite particles and copper wires may be from a few hundred micrometers up to about two millimeters, so as to provide a desired current and power capacity for the negative electrode. The negative electrode is the anode during battery cell discharge and is often referred to as the anode in this specification.

A positive electrode is shown, comprising a positive current collector foil 16 and, on each major face, a coextensive, overlying, porous layer 18 of a resin-bonded, particulate, positive electrode material mixed with compatible metal wires. Positive current collector foil is often formed of aluminum. Positive current collector foil 16 also has a connector tab 16′ for electrical connection with other electrodes in a grouping of lithium-ion cells or with other electrodes in other cells that may be packaged together in the assembly of a lithium-ion battery. The positive current collector foil 16 and its opposing coating layers 18 of mixtures porous positive electrode material and metal wires are typically formed in a size and shape that are complementary to the dimensions of an associated negative electrode. An example of a suitable positive electrode composition is a mixture of NMC particles and aluminum wires. Conductive filler particles may be included in the resin-bonded mixture. A portion of porous electrode layer 18 is broken out and enlarged to better illustrate, schematically, the mixture of aluminum wires 19 and NMC particles 17. The positive electrode is the cathode during cell discharge and is often referred to as the cathode in this specification,

In the illustration of FIG. 1, the two electrodes are substantially identical in their shapes and assembled in a lithium-ion cell with a major outer surface of the negative electrode material 14 facing a major outer surface of the positive electrode material 18. The thicknesses of the rectangular positive current collector foil 16 and the rectangular layer of positive electrode material 18 are typically determined to complement the negative electrode material 14 in producing the intended electrochemical capacity of the lithium-ion cell. The thicknesses of current collector foils are typically in the range of about 6 to 25 micrometers. And, in practices of this invention, the thicknesses of the respective electrode materials with their mixed-in wires, are typically from 200 micrometers up to about two millimeters.

A thin porous separator layer 20 is interposed between a major outer face of the negative electrode layer 14 of the mixture of electrode material particles and wires (as illustrated in FIG. 1) and a major outer face of the positive electrode particulate material/wire layer 18. A like separator layer 20 could also be placed against each of the opposite outer layer of negative electrode material 14 and the opposite outer layer of positive electrode material 18 if the illustrated individual cell assembly 10 is to be combined with like assemblies of cell members to form a battery with many cells, for example, many stacked cells.

In many battery constructions, the separator material is a porous layer of a polyolefin, such as polyethylene (PE) or polypropylene (PP). Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer 20 is used to prevent direct electrical contact between the facing negative and positive electrode material layers 14, 18, and is shaped and sized to serve this function. In the assembly of the cell, the facing major faces of the electrode material/wire layers 14, 18 are pressed against the major area faces of the separator membrane 20. A liquid electrolyte is typically injected into the pores of the separator and electrode material layers.

The electrolyte for the lithium-ion cell is often a lithium salt dissolved in one or more organic liquid solvents. Examples of suitable salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and solvent is selected for providing suitable mobility and transport of lithium ions in the operation of the cell. The electrolyte is carefully dispersed into and between closely spaced layers of the electrode elements and separator layers. The electrolyte is not illustrated in the drawing figure but it is illustrated in FIG. 3.

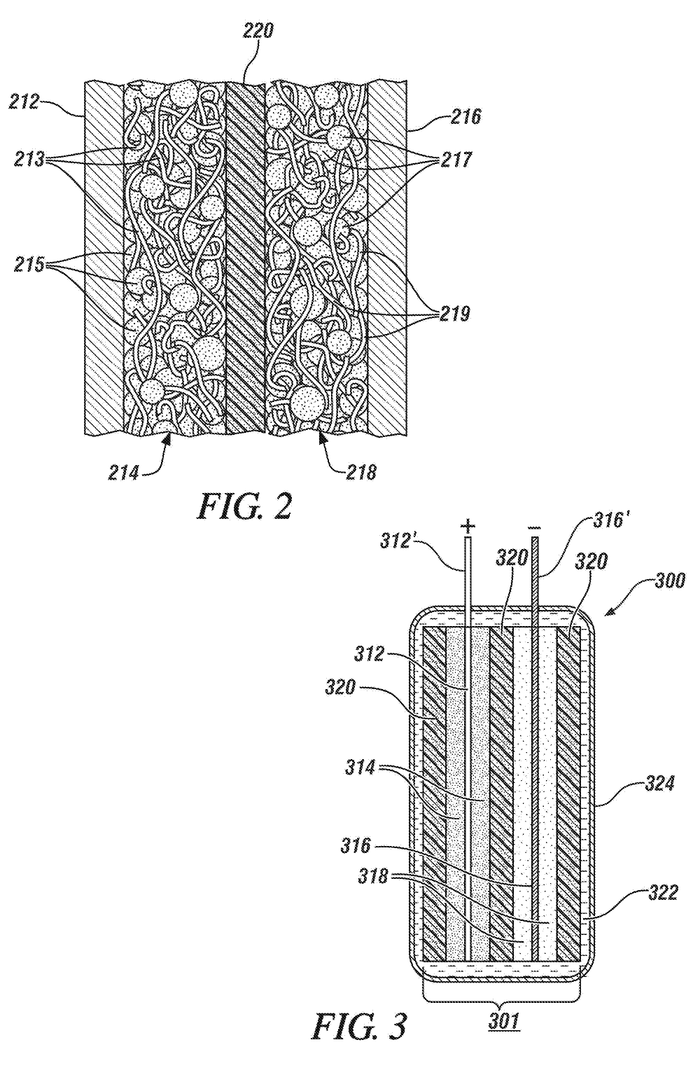

FIG. 2 is an enlarged schematic illustration of a porous anode layer 214 bonded one of its sides to one face of a copper current collector foil 212. The other major face of porous anode layer 214 is placed coextensively against one side of a porous, electrically insulating separator 220. Placed against the other face of separator 220 is one side of a porous cathode layer 218. The second side of porous cathode layer 218 is bonded to an aluminum current collector foil 216.

As illustrated schematically in FIG. 2, porous anode layer comprises micrometer-size particles of active anode material 215 mixed with micrometer cross-section wires 213. As suggested above in this text, the particles of active anode material 215 may be formed of graphite or other suitable lithium ion intercalating form of carbon. Several other suitable anode materials are listed above in this specification. In FIG. 2, the particles of anode material 215 are illustrated as being spherical. The anode materials may have other shapes, but it is preferred that the particles be shaped for mixing and close packing around wires 213 while leaving suitable pore space for infiltration with the liquid electrolyte which is introduced into an assembled cell. The wires 213 may be formed, for example, of copper.

Porous cathode layer comprises micrometer-size particles of active cathode material 217 mixed with wires 219 and resin-bonded as a porous layer to an aluminum current collector foil 216. As suggested above in this text, the particles of active cathode material 217 may be formed of NMC (lithium nickel manganese cobalt oxide). Several other suitable cathode materials are listed above in this specification. In FIG. 2, the particles of cathode material 217 are also illustrated as being spherical. But the cathode materials may have other shapes suitable for mixing and close packing around wires 219 while leaving suitable pore space for infiltration with the liquid electrolyte which is introduced into an assembled cell. The wires 219 may be formed, for example, of aluminum.

FIG. 3 presents a simplified, schematic, cross-sectional side-view of an assembly 300 of a single cell 301 of lithium-ion battery electrode materials assembled into a polymer-coated, aluminum foil pouch 324. The cell 301 with electrode materials comprises a cathode current collector foil 316 coated on both major sides with a porous layer of a mixture of active material particles 318 for a lithium-ion battery cathode. Cell 301 also comprises an anode current collector foil 312 coated on both sides with a porous layer mixture of active material particles 314 for a lithium-ion battery anode. The two electrodes are rectangular in shape (like those illustrated in FIG. 1). The opposing major faces of the anode and cathode are physically separated by porous rectangular polymer separator layer 320 which in some embodiments may be wound from the full outer surface of the cathode, around one edge of the cathode to separate the adjoining face of the anode and the cathode, around the edge of the anode to cover the outer face of the anode. The two electrodes with their mixed wires and electrode materials are placed within a closely spaced pouch container 324. The pouch 324 contains a non-aqueous electrolyte solution 322 which permeates and fills the pores of the separator 320 and of the respective active anode and cathode coating layers 314, 318. The respective current collector foils 312, 316 have uncoated tabs 312′, 316′ extending up from their top sides and through the top surface of the pouch container 324.

At least one of the anode and cathode of each lithium-ion cell, and preferably both, are formed by preparing a mixture of particles of suitable electrode material and compatible electrically conductive metal or carbon wires or wire-like shapes. As described in the Summary section of this specification, the metal or carbon members may be used in forms other than wires. But they are selected to be compatible with the particles of active electrode material and with the current collector to which the electrode mixture is resin-bonded as a porous layer. In many electrode layers it is preferred that the length of the wires be about ten times the thickness of the layer of electrode material. The wires may, for example, experience three to five folds in the electrode layer. The wires are often mixed with the particles of electrode material in amounts such that the wires constitute up to about 0.1 to about 20 percent by weight (or 0.1 to 30 percent by volume) of the wire/electrode material particle mixture.

The individual members of the wire and particle mixture are coated or otherwise suitably combined with a suitable amount of a bonding material. For example, the particle and wire mixture may be dispersed or slurried with a solution of a suitable resin, such as polyvinylidene difluoride dissolved in N-methyl-2-pyrrolidone, and spread and applied to a surface of a current collector in a porous layer. Other suitable binder resins include carboxymethyl cellulose/styrene butadiene rubber resins (CMC/SBR). The binders are not electrically conducive and should be used in a minimal suitable amount to obtain a durable coating of porous electrode material without fully covering the surfaces of the wires and particles of electrode material. After the bonding action or reaction is completed, a porous layer of mixed wires and electrode material particles is formed on the current collector. The mixed wires and electrode material particles are bonded to each other and one side of the layer is bonded to the current collector.

It is preferred that the porous layers of electrode materials have a generally uniformly distributed porosity and total pore volume produced by the pore spaces between the intermixed wires and particles of electrode material. Such porosity and pore volume permits the electrode layers to be suitably generally uniformly infiltrated with a volume of suitable liquid electrolyte. The interaction of the combination of the volume of liquid electrolyte material and the wires and particles of electrode materials produce the desired functions of the electrodes. In most electrode structures, the total pore volume is suitably in the range of about 15 to 50 percent of the superficial outline volume of the applied electrode layer.

As illustrated in FIG. 3, each anode layer 314 or cathode layer 318 has one surface bonded to its current collector 312, 316 and the other surface lies against an adjacent surface of a porous separator 320. The volume and nature of the total number of individual pores between the wires and particles of the electrode is to permit an inserted liquid electrolyte 322 to permeate the electrode layers 314, 318 from the separator side to the current collector side of the anode or cathode. Lithium ions must be accessible to the surfaces of the particles of the anode or cathode material. And the amount and locations of the wires enhances the conduction of electrons into the current collector. Further the linear wires dispersed among the electrode particles reinforce the electrode layer and permit a thicker layer of electrode particles to be bonded to and supported on the current collector.

### Methods of Preparing the Mixtures of Electrode Materials and Wires

In general, the simplest way to obtain the mixtures of electrode particles and wires is to start with the elemental metal wires, metal alloy wires, or carbon wires and to blend and uniformly mix the wires with the particles of selected electrode material. In many embodiments of the invention it is preferred the wires make up about 5 wt % to about 10 wt % of the mixture of wires and of particles of active electrode material. If desired, a suitable small quantity of conductive carbon filler particles may be added to the mixture of wires and particles of electrode material. Subsequently a suitable resin or resin-containing solution may be added to the mixture in an amount to bond the wire/particle mixture as a porous layer to one side or both sides of a current collector foil for the electrode.

But there may be instances when it is desirable to obtain wire shapes that are not readily available in metal form. There are metal oxide shapes that would serve well in a mixture with electrode particle if the metal oxides were converted to elemental metal. Small wire-like or rod-like particles of copper oxide, silver oxide, or other metal oxides may offer potential for use in electrode mixtures. For example, suitably sized, elongated particles of copper oxide may be mixed with carbon particles as an anode mixture and the mixture resin-bonded to a surface of a current collector.

The bonded porous anode mixture may be exposed to a hydrogen atmosphere at a temperature of, e.g., 120° to 150° C. for a brief time suitable to chemically reduce the copper oxide particles to copper wires or the like. Silver oxide particles may be utilized in a like manner.

The reduction of CuO to Cu typically results in a thirty to fifty percent decrease in volume of the CuO particles (depending on the diameter of the copper oxide particles or wires) and a decrease in diameter of the resulting copper particles. This can improve the access of the carbon electrode material particles to the now-reduced copper particles in the resin-bonded layer on the current collector surface. And the reduced copper particles, like an initial use of copper wires, enhance electron conductivity, and improve the mechanical strength of the electrode layer.

### Benefits of the Wire/Electrode Material Particle Mixture

It is found that the intimate mixture of the wires with electrode particles enable a greater thickness of electrode material to be bonded to the current collector. The presence of a suitable content of wires permits a thicker layer, up to a total thickness of about two millimeters, to be formed on each side of the current collector. The presence of the wires both enhances the electrochemical function of the thicker electrode layer and strengthens the layer. The presence of the intermixed wires with the electrode particles increases each of the power capability of the electrode, the energy density of the electrode, its working life, and the flexibility of the electrode as it is charged and discharged. Further, the cost per unit of capacity ($/Wh) of the electrode is reduced.

When the metal or carbon wire-containing electrodes are assembled with their interposed porous separators, the assembled cells are infiltrated with a lithium ion-containing liquid electrolyte. The liquid electrolyte wets the surface of the wires (strips, fibers, tubes, etc.) to create thin (nanometer to submicron in size) channels for lithium ion (Li+) conduction along the surface of the wires. This conduction along the surfaces of the wires supplements lithium ion conduction in the continuous and interconnected liquid electrolyte that is also filling the pores between the particles of electrode material and the conductive wires. Likewise, when metal oxide particles are initially mixed with particles of electrode material, the subsequently added liquid electrolyte interacts with the newly formed surfaces of the reduced metal wires.

### ILLUSTRATIVE EXAMPLES

Graphite particles are suitable for use as a lithium ion intercalating/de-intercalating anode material for a lithium-ion battery cell. Graphite particles may, for example, be resin bonded as a porous layer of anode material to one side of a copper current collector foil. In an example, in which the thickness of the graphite anode layer was 50 micrometers, the energy density of the anode layer was 163.8 Wh/kg. When the thickness of the graphite anode layer was increased to 90 micrometers, the energy density was increased to 180.3 Wh/g. The material cost ($/Wh) was reduced about ten percent by use of the thicker anode layer. But thicker layers of graphite anode layers bonded to current collector foils were not found to be durable over required periods of use.

When copper wires were mixed with the graphite anode particles, thicker anode layers could be formed on copper current collector foils to achieve significantly higher energy densities (Wh/kg) and with significantly lower material costs in $/Wh. The copper wires had diameters of about 10 μm and lengths of about 300 μm.

1. Mixtures containing 3 wt % copper wires and the balance graphite particles were formed as porous electrode layers on one side of like copper current collector foils in thicknesses of 50 μm, 90 μm, 200 μm, and 300 μm. The corresponding energy densities (from thinnest layer to thickest layer) were respectively 160.4 Wh/kg, 179.4 Wh/kg, 205.1 Wh/kg, and 207.1 Wh/kg. The material cost $/Wh decreased appreciably in the anode layers of 200 μm, and 300 μm thickness.

2. Mixtures containing 5 wt % copper wires and the balance graphite particles were formed as porous electrode layers on one side of like copper current collector foils in thicknesses of 50 μm, 90 μm, 200 μm, and 300 μm. The corresponding energy densities (from thinnest layer to thickest layer) were respectively 159.5 Wh/kg, 178.7 Wh/kg, 203.7 Wh/kg, and 205.6 Wh/kg. The material cost $/Wh decreased appreciably in the anode layers of 200 μm, and 300 μm thickness.

3. Mixtures containing 8 wt % copper wires and the balance graphite particles were formed as porous electrode layers on one side of like copper current collector foils in thicknesses of 50 μm, 90 μm, 200 μm, and 300 μm. The corresponding energy densities (from thinnest layer to thickest layer) were respectively 158.5 Wh/kg, 177.0 Wh/kg, 201.9 Wh/kg, and 203.6 Wh/kg. The material cost $/Wh decreased appreciably in the anode layers of 200 μm, and 300 μm thickness.

4. Mixtures containing 10 wt % copper wires and the balance graphite particles were formed as porous electrode layers on one side of like copper current collector foils in thicknesses of 50 μm, 90 μm, 200 μm, and 300 μm. The corresponding energy densities (from thinnest layer to thickest layer) were respectively 157.5 Wh/kg, 176.1 Wh/kg, 200.3 Wh/kg, and 201.9 Wh/kg. The material cost $/Wh decreased appreciably in the anode layers of 200 μm, and 300 μm thickness.

5. Mixtures containing 15 wt % copper wires and the balance graphite particles were formed as porous electrode layers on one side of like copper current collector foils in thicknesses of 50 μm, 90 μm, 200 μm, and 300 μm. The corresponding energy densities (from thinnest layer to thickest layer) were respectively 155.2 Wh/kg, 172.7 Wh/kg, 196.3 Wh/kg, and 197.8 Wh/kg. The material cost $/Wh decreased appreciably in the anode layers of 200 μm, and 300 μm thickness.

6. Mixtures containing 20 wt % copper wires and the balance graphite particles were formed as porous electrode layers on one side of like copper current collector foils in thicknesses of 50 μm, 90 μm, 200 μm, and 300 μm. The corresponding energy densities (from thinnest layer to thickest layer) were respectively 152.7 Wh/kg, 169.6 Wh/kg, 192.3 Wh/kg, and 193.4 Wh/kg. The material cost $/Wh decreased appreciably in the anode layers of 200 μm, and 300 μm thickness.

The presence of the copper wires mixed with the graphite anode particles permitted the formation of physically stable and viable electrode layers of greater thicknesses with increasing total electrode capacity in Wh with little effect on the energy density (Wh/kg) of the cell. The presence of the copper wires contributed to ion conductivity and electron conductivity through the increasingly thick electrode layers bonded to the current collector. The presence of the copper wires contributes significantly to the strength of the electrode layer and enables more electrode capacity.

Thus, the incorporation of wires or like-shaped metal and/or carbon particles in intimate, generally uniform mixtures with particles of anode or cathode materials improved the capabilities and performances of the electrodes in lithium-ion cells and batteries.

The above illustrations and examples are intended to describe characteristics and advantages of the invention and not to limit its scope.

1. A lithium-ion battery comprising an anode, a cathode, and a liquid lithium ion-containing electrolyte solution, at least one of the anode and cathode comprising a porous electrode layer formed of a mixture of particles of an active electrode material for the anode or cathode and pieces of electrically conductive wires, the mixture being bonded as the porous electrode layer to a metal current collector for the anode or cathode with its pores being infiltrated with the electrolyte solution, the thickness of the porous electrode layer on the current collector for the anode or cathode being in the range of sixty micrometers to two millimeters.

2. A lithium-ion battery as stated in claim 1 in which the electrically conductive wires are formed of an elemental metal, a metal alloy, or carbon, the electrically conductive wires having diameters or major cross-sectional dimensions in the range of 0.05 micrometer to 100 micrometers and lengths in the range of one micrometer to 10 millimeters, the electrically conductive wires being present in an amount of 0.1 to 20 percent of the total weight of the mixture of electrically conductive wires and the particles of active electrode material.

3. A lithium-ion battery as stated in claim 1 in which the anode comprises a mixture of particles of active anode material mixed with pieces of wire, the mixture of particles of anode material and the pieces of wire being resin-bonded as a porous layer to a surface of a metal current collector for the anode.

4. A lithium-ion battery as stated in claim 1 in which the anode comprises a mixture of particles of active anode material mixed with pieces of copper wire, the mixture of particles of anode material and the pieces of copper wire being bonded as a porous layer to a surface of a copper foil current collector for the anode.

5. A lithium-ion battery as stated in claim 1 in which the anode comprises a mixture of particles of lithium titanate, Li₄Ti₅O₁₂, mixed with pieces of aluminum wire, the mixture of particles of lithium titanate and pieces of aluminum wire being bonded as a porous layer to a surface of an aluminum foil current collector for the anode.

6. A lithium-ion battery as stated in claim 1 in which the anode comprises a mixture of particles of active anode material mixed with pieces of copper wire, the particles of active anode material having average dimensions in the range of 0.5 to 30 micrometers and the pieces of copper wires having diameters or widths in the range of 0.05 to 100 micrometers, the mixture of particles of anode material and pieces of copper wire being bonded as a porous layer to a surface of a copper foil current collector for the anode.

7. A lithium-ion battery as stated in claim 1 in which the cathode comprises a mixture of particles of active cathode material mixed with pieces of wire, the mixture of particles of active cathode material and the pieces of wire being resin-bonded as a porous layer to a surface of a metal current collector for the cathode.

8. A lithium-ion battery as stated in claim 1 in which the cathode comprises a mixture of particles of active cathode material mixed with pieces of aluminum wire, the particles of active cathode material and pieces of aluminum wire being bonded as a porous layer to a surface of an aluminum foil current collector for the cathode.

9. A lithium-ion battery as stated in claim 1 in which the cathode comprises a mixture of particles of active cathode material mixed with pieces of aluminum wire, the particles of active cathode material having average dimensions in the range of 0.3 to 30 micrometers and the pieces of aluminum wires having diameters or widths in the range of 0.05 to 100 micrometers, the particles of active cathode material and of aluminum wire being bonded as a porous layer to a surface of an aluminum foil current collector for the cathode.

10. A lithium-ion battery as stated in claim 1 in which
the anode comprises a mixture of particles of active anode material mixed with pieces of wire, the mixture of particles of anode material and pieces of wire being resin-bonded as a porous layer to a surface of a metal current collector for the anode, and
the cathode comprises a mixture of particles of active cathode material mixed with pieces of wire, the particles of active cathode material and pieces of wire being resin-bonded as a porous layer to a surface of a metal current collector for the cathode.

11. A lithium-ion battery as stated in claim 1 in which
the anode comprises a mixture of particles of active anode material and pieces of copper wire, the mixture of particles of anode material and pieces of copper wire being bonded as a porous layer to a surface of a copper foil current collector for the anode, and
the cathode comprises a mixture of particles of active cathode material and pieces of aluminum wire, the mixture of particles of active cathode material and pieces of aluminum wire being bonded as a porous layer to a surface of an aluminum foil current collector for the cathode.

12. A lithium-ion battery as stated in claim 1 in which
the anode comprises a mixture of particles of active anode material and pieces of copper wire, the particles of active anode material having average dimensions in the range of 0.5 to 30 micrometers and the pieces of copper wires having diameters or widths in the range of 0.05 to 100 micrometers, the mixture of particles of anode material and pieces of copper wire being bonded as a porous layer to a surface of a copper foil current collector for the anode, and
the cathode comprises a mixture of particles of active cathode material mixed with pieces of wire, the particles of active cathode material having average dimensions in the range of 0.3 to 30 micrometers and the pieces of aluminum wires having diameters or widths in the range of 0.05 to 100 micrometers, the mixture of particles of active cathode material and pieces of wire being bonded as a porous layer to a surface of an aluminum foil current collector for the cathode.

13. A lithium-ion battery as stated in claim 1 in which
the anode comprises a mixture of particles of active anode material mixed with carbon wires, the mixture of particles of anode material and carbon wires being bonded as a porous layer to a surface of a metal current collector for the anode, and
the cathode comprises a mixture of particles of active cathode material mixed with carbon wires, the mixture of particles of active cathode material and carbon wires being bonded as a porous layer to a surface of a metal current collector for the cathode.

14. A method of forming an anode or a cathode for a lithium-ion battery, the anode or cathode comprising active electrode particles bonded as a porous layer to a surface of a metal foil current collector, the method comprising:
mixing a predetermined amount of micrometer-size particles of active electrode material with a predetermined amount of electrically conductive metal wires or carbon wires, the electrically conductive wires being present in an amount of 0.1 to 20 percent of the total weight of the mixture of electrically conductive wires and the particles of active electrode material, and
bonding the mixture of particles of active electrode material and electrically conductive metal wires or carbon wires as a porous layer of electrode material to a surface of the metal foil current collector, the thickness of the porous layer of electrode material being in the range of from two hundred micrometers up to two millimeters.

15. A method of forming an anode or a cathode for a lithium-ion battery as stated in claim 14 in which micrometer-size particles of active anode material for a lithium-ion battery are mixed with copper wires and the mixture is bonded to a copper current collector foil, the diameters or cross-sections of the wires being no greater than twice the largest dimensions of the particles of intermixed electrode material and the lengths of the wires being no greater than ten times the thickness of the bonded porous layer of electrode material.

16. A method of forming an anode or a cathode for a lithium-ion battery as stated in claim 14 in which micrometer-size particles of active anode material for a lithium-ion battery are mixed with copper fibers and the mixture is bonded to a copper current collector foil.

17. A method of forming an anode or a cathode for a lithium-ion battery as stated in claim 14 in which micrometer-size particles of active cathode material for a lithium-ion battery are mixed with aluminum wires and the mixture is bonded to an aluminum current collector foil, the diameters or cross-sections of the wires being no greater than twice the largest dimensions of the particles of intermixed electrode material and the lengths of the wires being no greater than ten times the thickness of the bonded porous layer of electrode material.

18. A method of forming an anode or a cathode for a lithium-ion battery as stated in claim 14 in which micrometer-size particles of lithium nickel manganese cobalt oxide as a cathode material for a lithium-ion battery are mixed with copper wires and the mixture is bonded to a copper current collector foil.

19. A method of forming an anode or a cathode for a lithium-ion battery, the anode or cathode comprising active electrode particles bonded as a porous layer to a surface of a metal foil current collector, the method comprising:
mixing a predetermined amount of micrometer-size particles of active electrode material with a predetermined amount of metal oxide particles of wire-like shapes;
bonding the mixture of particles of active electrode material and metal oxide particles as a porous layer of electrode material to a surface of the metal foil current collector, the thickness of the porous layer being up to two millimeters; and
placing the current collector foil with the bonded porous mixture of particles of active electrode material and metal oxide particles in a hydrogen gas atmosphere and reacting the metal oxide particles with hydrogen to form electrically conductive metal wires in place of the metal oxide particles in the porous bonded layer of electrode material.

20. A method of forming an anode or a cathode for a lithium-ion battery as stated in claim 19 in which a predetermined amount of active electrode particles are mixed with particles of copper oxide or silver oxide and the particles of copper oxide or silver oxide are reduced by reaction with hydrogen to copper wires or silver wires preparatory to the formation of an electrode for a lithium battery.

21. A method of forming an anode or a cathode for a lithium-ion battery as stated in claim 19 in which a predetermined amount of active anode particles are mixed with particles of copper oxide or silver oxide and the particles of copper oxide or silver oxide are reduced by reaction with hydrogen to copper wires or silver wires preparatory to the formation of an anode for a lithium battery.

22. A combination of a device requiring electrical energy and a lithium-ion battery composed and sized to provide the electrical energy for the device, the lithium-ion battery comprising an anode, a cathode, and a liquid lithium ion-containing electrolyte solution, at least one of the anode and cathode comprising a porous electrode layer formed of a mixture of particles of an active electrode material for the anode or cathode and pieces of electrically conductive wires, the mixture being bonded as the porous electrode layer to a metal current collector for the anode or cathode with its pores being infiltrated with the electrolyte solution, the thickness of the porous electrode layer on the current collector for the anode or cathode being in the range of sixty micrometers to two millimeters, the electrically conductive wires being present in an amount of 0.1 to 20 percent of the total weight of the mixture of electrically conductive wires and the particles of active electrode material.

23. A combination of a device and a lithium-ion battery as stated in claim 22 in which the device is an automotive vehicle comprising wheels that are driven at least a part of the time of their operation by an electric motor that is powered by the lithium-ion battery,

24. A combination of a device and a lithium-ion battery as stated in claim 22 in which the electrically conductive wires of the lithium-ion battery are formed of an elemental metal, a metal alloy, or carbon, the electrically conductive wires having diameters or major cross-sectional dimensions in the range of 0.05 micrometer to 100 micrometers and lengths in the range of one micrometer to 10 millimeters.

25. A combination of a device and a lithium-ion battery as stated in claim 22 in which the anode of the lithium-ion battery comprises a mixture of particles of active anode material mixed with pieces of wire, the mixture of particles of anode material and the pieces of wire being resin-bonded as a porous layer to a surface of a metal current collector for the anode.

26. A combination of a device and a lithium-ion battery as stated in claim 22 in which the anode of the lithium-ion battery comprises a mixture of particles of active anode material mixed with pieces of copper wire, the mixture of particles of anode material and the pieces of copper wire being bonded as a porous layer to a surface of a copper foil current collector for the anode.

27. A combination of a device and a lithium-ion battery as stated in claim 22 in which the anode of the lithium-ion battery comprises a mixture of particles of active anode material mixed with pieces of copper wire, the particles of active anode material having average dimensions in the range of 0.5 to 30 micrometers and the pieces of copper wires having diameters or widths in the range of 0.05 to 100 micrometers, the mixture of particles of anode material and pieces of copper wire being bonded as a porous layer to a surface of a copper foil current collector for the anode.

28. A combination of a device and a lithium-ion battery as stated in claim 22 in which the cathode of the lithium-ion battery comprises a mixture of particles of active cathode material mixed with pieces of wire, the mixture of particles of active cathode material and the pieces of wire being bonded as a porous layer to a surface of a metal current collector for the cathode.

29. A combination of a device and a lithium-ion battery as stated in claim 22 in which the cathode of the lithium-ion battery comprises a mixture of particles of active cathode material mixed with pieces of aluminum wire, the particles of active cathode material and pieces of aluminum wire being bonded as a porous layer to a surface of an aluminum foil current collector for the cathode.

30. A combination of a device and a lithium-ion battery as stated in claim 22 in which the cathode of the lithium-ion battery comprises a mixture of particles of active cathode material mixed with pieces of aluminum wire, the particles of active cathode material having average dimensions in the range of 0.3 to 30 micrometers and the pieces of aluminum wires having diameters or widths in the range of 0.05 to 100 micrometers, the particles of active cathode material and of aluminum wire being bonded as a porous layer to a surface of an aluminum foil current collector for the cathode.
